(19) United States
(12) Patent Application Publication
(10) Pub. No.: US 2025/0015950 A1
(43) Pub. Date: Jan. 9, 2025

(54) METHOD AND DEVICE FOR TRANSMITTING AND RECEIVING NEW RADIO TECHNOLOGY (NR) PHYSICAL DOWNLINK CONTROL CHANNEL (PDCCH) IN WIRELESS COMMUNICATION SYSTEM

(71) Applicant: KT CORPORATION, Gyeonggi-do (KR)

(72) Inventor: Kyujin PARK, Gyeonggi-do (KR)

(73) Assignee: KT CORPORATION, Gyeonggi-do (KR)

(21) Appl. No.: 18/890,650

(22) Filed: Sep. 19, 2024

(30) Foreign Application Priority Data
Mar. 23, 2022 (KR) 10-2022-0036327
Aug. 25, 2022 (KR) 10-2022-0107137
Mar. 20, 2023 (KR) 10-2023-0035798

(51) Int. Cl. H04L 5/00; H04L 1/00

(52) U.S. Cl. CPC H04L 5/005; H04L 1/0013; H04L 5/0007

(57) ABSTRACT

Provided are a method and a device for transmitting and receiving a new radio technology (NR) physical downlink control channel (PDCCH) in a wireless communication system. In one or a plurality of orthogonal frequency division multiplexing (OFDM) symbols in a slot, a terminal monitors a PDCCH transmitted by a base station, wherein the slot is used for a long term evolution (LTE) cell-specific reference signal (CRS), and the terminal receives, from the base station, in at least one OFDM symbol in the slot, a demodulation reference signal (DM-RS) for the decoding of the PDCCH. A resource element (RE) used for the DM-RS for the decoding of the PDCCH does not overlap with an RE used for a LTE CRS.

### TECHNICAL FIELD

The present disclosure relates to a 3GPP 5G NR system.

### BACKGROUND ART

As more communication devices require greater communication traffic, necessity for a next generation 5G system, which is enhanced compared to a legacy LTE system, is emerging. In the next generation 5G system, scenarios can be classified into Enhanced Mobile BroadBand (eMBB), Ultra-reliability and low-latency communication (URLLC), Massive Machine-Type Communications (mMTC), and the like.

Here, eMBB corresponds to a next generation mobile communication scenario having characteristics such as high spectrum efficiency, high user experienced data rate, high peak data rate, and the like. URLLC corresponds to a next generation mobile communication scenario having characteristics such as ultra-reliable, ultra-low latency, ultra-high availability, and the like (e.g., V2X, Emergency Service, Remote Control). mMTC corresponds to a next generation mobile communication scenario having characteristics such as low cost, low energy, short packet, and massive connectivity (e.g., IoT).

### DISCLOSURE OF INVENTION

### Technical Problem

The disclosure provides a method and device for transmitting and receiving a new radio technology (NR) physical downlink control channel (PDCCH) in a wireless communication system.

### Solution to Problem

According to an n embodiment, the disclosure provides a method for a terminal to monitor a new radio technology (NR) physical downlink control channel (PDCCH) in a wireless communication system. The method may include: monitoring the PDCCH in one orthogonal frequency division multiplexing (OFDM) symbol or a plurality of OFDM symbols within a slot that is used for a long term evolution (LTE) cell-specific reference signal (CRS); and receiving a demodulation reference signal (DM-RS) for decoding of the PDCCH in at least one OFDM symbol within the slot, wherein a resource element (RE) used for the DM-RS for the decoding of the PDCCH does not overlap with an RE used for the LTE CRS.

According to another embodiment, the disclosure provides a method for a base station to transmit a new radio technology (NR) physical downlink control channel (PDCCH) in a wireless communication system. The method may include: configuring one orthogonal frequency division multiplexing (OFDM) symbol or a plurality of OFDM symbols within a slot to transmit the PDCCH, the slot being used for a long term evolution (LTE) cell-specific reference signal (CRS); allocating a demodulation reference signal (DM-RS) for decoding of the PDCCH to at least one OFDM symbol within the slot; and transmitting the PDCCH and the DM-RS for the decoding of the PDCCH, wherein a resource element (RE) used for the DM-RS for the decoding of the PDCCH does not overlap with an RE used for the LTE CRS.

According to further another embodiment, the disclosure provides a communication device in a wireless communication system. The communication device may include at least one processor; and at least one memory configured to store instructions and operably electrically connectable to the at least one processor, wherein operations performed based on the instructions executed by the at least one processor include: monitoring a new radio technology (NR) physical downlink control channel (PDCCH) in one orthogonal frequency division multiplexing (OFDM) symbol or a plurality of OFDM symbols within a slot that is used for a long term evolution (LTE) cell-specific reference signal (CRS); and receiving a demodulation reference signal (DM-RS) for decoding of the PDCCH in at least one OFDM symbol within the slot, wherein a resource element (RE) used for the DM-RS for the decoding of the PDCCH does not overlap with an RE used for the LTE CRS.

According to still another embodiment, the disclosure provides a base station in a wireless communication system. The base station may include: at least one processor; and at least one processor; and at least one memory configured to store instructions and operably electrically connectable to the at least one processor, wherein operations performed based on the instructions executed by the at least one processor include: configuring one orthogonal frequency division multiplexing (OFDM) symbol or a plurality of OFDM symbols within a slot to transmit a new radio technology (NR) physical downlink control channel (PDCCH), the slot being used for a long term evolution (LTE) cell-specific reference signal (CRS); allocating a demodulation reference signal (DM-RS) for decoding of the PDCCH to at least one OFDM symbol within the slot; and transmitting the PDCCH and the DM-RS for the decoding of the PDCCH, wherein a resource element (RE) used for the DM-RS for the decoding of the PDCCH does not overlap with an RE used for the LTE CRS.

According to yet another embodiment, the disclosure provides a computer readable storage medium storing instructions that, when executed by one or more processors, cause the one or more processors to: monitoring a new radio technology (NR) physical downlink control channel (PDCCH) in one orthogonal frequency division multiplexing (OFDM) symbol or a plurality of OFDM symbols within a slot that is used for a long term evolution (LTE) cell-specific reference signal (CRS); and receiving a demodulation reference signal (DM-RS) for decoding of the PDCCH in at least one OFDM symbol within the slot, wherein a resource element (RE) used for the DM-RS for the decoding of the PDCCH does not overlap with an RE used for the LTE CRS.

When symbols where the LTE CRS is included and symbols where the LTE CRS is not included are mixed in the plurality of OFDM symbols in which the PDCCH is monitored, the at least one OFDM symbol, from which the terminal receives the DM-RS for the decoding of the PDCCH, may not include the LTE CRS.

Meanwhile, when symbols where the LTE CRS is included and symbols where the LTE CRS is not included are mixed in the plurality of OFDM symbols for the PDCCH transmission, the DM-RS for the decoding of the PDCCH may be transmitted from the base station to the terminal through only the at least one symbol where the LTE CRS is not included.

Further, DM-RS puncturing may be applied to the RE used for the LTE CRS.

Further, the configuration information of the LTE CRS may be transmitted through a radio resource control (RRC) signaling, and the configuration information of the LTE CRS may be rate matching pattern configuration information of the LTE CRS for the PDCCH.

### Advantageous Effects of Invention

According to embodiments, a new radio technology (NR) physical downlink control channel (PDCCH) is efficiently transmitted and received in a wireless mobile communication system.

### BRIEF DESCRIPTION OF DRAWINGS

FIG. 1 illustrates a wireless communication system.

FIG. 2 illustrates a structure of a radio frame used in NR.

FIGS. 3A to 3C illustrate exemplary architectures for a wireless communication service.

FIG. 4 illustrates a slot structure of a new radio (NR) frame.

FIG. 5 shows an example of a subframe type in NR.

FIG. 6 illustrates a structure of a self-contained slot.

FIG. 7 illustrates cross-carrier scheduling in a carrier aggregation system.

FIG. 8 shows an example of dynamic spectrum sharing (DSS) technology.

FIGS. 9 to 11 show some examples of a cell-specific reference signal (CRS) structure when one or more antennas are used.

FIG. 12 shows an example of a 5G NR physical downlink control channel (PDCCH).

FIG. 13 illustrates an operation method of a terminal according to an embodiment of the present specification.

FIG. 14 illustrates an operation method of a base station according to an embodiment of the present specification.

FIG. 15 shows apparatuses according to an embodiment of the disclosure.

FIG. 16 is a block diagram showing a configuration of a terminal according to an embodiment of the disclosure.

FIG. 17 is a configuration block diagram of a processor in which the disclosure is implemented.

FIG. 18 is a detailed block diagram of a transceiver of a first apparatus shown in FIG. 15 or a transceiving unit of an apparatus shown in FIG. 16.

### MODE FOR THE INVENTION

The technical terms used herein are intended to merely describe specific embodiments and should not be construed as limiting the disclosure. Further, the technical terms used herein should be, unless defined otherwise, interpreted as having meanings generally understood by those skilled in the art but not too broadly or too narrowly. Additionally, the technical terms used herein, which are determined not to exactly represent the spirit of the disclosure, should be replaced by or understood by such technical terms as being able to be exactly understood by those skilled in the art. Finally, the general terms used herein should be interpreted in the context as defined in the dictionary, but not in an excessively narrowed manner.

The expression of the singular form in the disclosure includes the meaning of the plural form unless the meaning of the singular form is definitely different from that of the plural form in the context. In the following description, the term ‘include’ or ‘have’ may represent the existence of a feature, a number, a step, an operation, a component, a part or the combination thereof described in the disclosure and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without departing from the scope of the disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the disclosure will be described in greater detail with reference to the accompanying drawings. In describing the disclosure, for ease of understanding, the same reference numerals are used to denote the same components throughout the drawings, and repetitive description on the same components will be omitted. Detailed description on well-known arts that are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to include its modifications, replacements or equivalents in addition to what is shown in the drawings.

In the disclosure, “A or B” may mean “only A”, “only B”, or “both A and B”. In other words, “A or B” in the disclosure may be interpreted as “A and/or B”. For example, “A, B or C” in the disclosure may mean “only A”, “only B”, “only C”, or “any combination of A, B and C”.

In the disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the disclosure, “at least one of A and B” may mean “only A”, “only B” or “both A and B”. In addition, the expression “at least one of A or B” or “at least one of A and/or B” in the disclosure may be interpreted as the same as “at least one of A and B”.

In addition, in the disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the disclosure may mean “for example”. In detail, when it is shown as “control information (PDCCH)”, “physical downlink control channel (PDCCH)” may be proposed as an example of “control information”. In other words, “control information” in the disclosure is not limited to “PDCCH”, and “PDDCH” may be proposed as an example of “control information”. In addition, even when shown as “control information (i.e., PDCCH)”, “PDCCH” may be proposed as an example of “control information”.

The technical features described individually in one drawing in this specification may be implemented separately or at the same time.

In the accompanying drawings, user equipment (UE) is illustrated by way of example, but the illustrated UE may be also referred to as a terminal, mobile equipment (ME), or the like. In addition, the UE may be a portable device such as a laptop computer, a mobile phone, a PDA, a smart phone, a multimedia device, or the like, or may be a non-portable device such as a PC or a vehicle-mounted device.

Hereinafter, the UE is used as an example of a device capable of wireless communication (eg, a wireless communication device, a wireless device, or a wireless apparatus). The operation performed by the UE may be performed by any device capable of wireless communication. A device capable of wireless communication may also be referred to as a radio communication device, a wireless device, or a wireless apparatus.

A base station, a term used below, generally refers to a fixed station that communicates with a wireless device, and may be used to cover the meanings of terms including an evolved-NodeB (eNodeB), an evolved-NodeB (eNB), a BTS (Base Transceiver System), an access point (Access Point), gNB (Next generation NodeB), RRH(remote radio head), TP(transmission point), RP(reception point), a repeater(relay), and so on.

Although embodiments of the disclosure will be described based on an LTE system, an LTE-advanced (LTE-A) system, and an NR system, such embodiments may be applied to any communication system corresponding to the aforementioned definition.

### Next-Generation Mobile Communication Network

With the success of long-term evolution (LTE)/LTE-A (LTE-Advanced) for the 4th generation mobile communication, the next generation, i.e., 5^{th} generation (so called 5G) mobile communication has been commercialized and the follow-up studies are also ongoing.

The 5^{th} generation mobile communications defined by the International Telecommunication Union (ITU) refers to communication providing a data transmission rate of up to 20 Gbps and a minimum actual transmission rate of at least 100 Mbps anywhere. The official name of the 5^{th} generation mobile telecommunications is ‘IMT-2020.’

The ITU proposes three usage scenarios, namely, enhanced Mobile Broadband (eMBB), massive Machine Type Communication (mMTC) and Ultra Reliable and Low Latency Communications (URLLC).

The URLLC relates to a usage scenario that requires high reliability and low latency. For example, services such as autonomous driving, factory automation, and augmented reality require high reliability and low latency (e.g., a delay time of less than 1 ms). The delay time of current 4G (LTE) is statistically 21 to 43 ms (best 10%) and 33 to 75 ms (median). This is insufficient to support a service requiring a delay time of 1 ms or less. Next, the eMBB usage scenario relates to a usage scenario requiring mobile ultra-wideband.

That is, the 5G mobile communication system supports higher capacity than the current 4G LTE, and may increase the density of mobile broadband users and support device to device (D2D), high stability, and machine type communication (MTC). The 5G research and development also aims at lower latency time and reduce battery consumption compared to a 4G mobile communication system to better implement the Internet of things. A new radio access technology (new RAT or NR) may be proposed for such 5G mobile communication.

An NR frequency band is defined as two types of frequency ranges: FR1 and FR2. The numerical value in each frequency range may vary, and the frequency ranges of the two types, FR1 and FR2, may, for example, be shown in Table 1 below. For convenience of description, FR1 among the frequency ranges used in the NR system may refer to a Sub-6 GHz range, and FR2 may refer to an above-6 GHz range, which may be called millimeter waves (mmWs).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values in the frequency range may vary in the NR system. For example, FR1 may range from 410 MHz to 7125 MHz as listed in [Table 1]. That is, FR1may include a frequency band of 6 GHZ (or 5850, 5900, and 5925 MHz) or above. For example, the frequency band of 6 GHz (or 5850, 5900, and 5925 MHz) or above may include an unlicensed band. The unlicensed band may be used for various purposes, such as, vehicle communication (e.g., autonomous driving).

Meanwhile, the 3GPP communication standards define downlink (DL) physical channels corresponding to resource elements (REs) carrying information originated from a higher layer, and DL physical signals which are used in the physical layer and correspond to REs that do not carry information originated from a higher layer. For example, physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as DL physical channels, and reference signals (RSs) and synchronization signals (SSs) are defined as DL physical signals. An reference signal (RS), also called a pilot signal, is a signal with a predefined special waveform known to both a gNode B (gNB) and a UE. For example, cell specific RS, UE-specific RS (UE-RS), positioning RS (PRS), and channel state information RS (CSI-RS) are defined as DL RSs. The 3GPP LTE/LTE-A standards define uplink (UL) physical channels corresponding to REs carrying information originated from a higher layer, and UL physical signals which are used in the physical layer and correspond to REs which do not carry information originated from a higher layer. For example, physical uplink shared channel (PUSCH), physical uplink control channel (PUCCH), and physical random access channel (PRACH) are defined as UL physical channels, and a demodulation reference signal (DMRS) for a UL control/data signal, and a sounding reference signal (SRS) used for UL channel measurement are defined as UL physical signals.

In the disclosure, the PDCCH/PCFICH/PHICH/PDSCH refers to a set of time-frequency resources or a set of REs, which carry downlink control information (DCI)/a control format indicator (CFI)/a DL acknowledgement/negative acknowledgement (ACK/NACK)/DL data. Further, the PUCCH/PUSCH/PRACH refers to a set of time-frequency resources or a set of REs, which carry UL control information (UCI)/UL data/a random access signal.

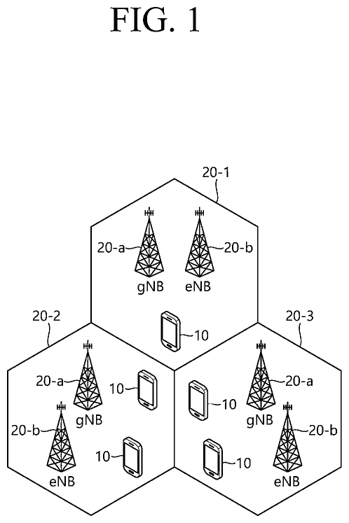

FIG. 1 illustrates a wireless communication system.

Referring to FIG. 1, the wireless communication system includes at least one base station (BS). The BS includes a gNodeB (or gNB) 20a and an eNodeB (or eNB) 20b. The gNB 20a supports the 5G mobile communication. The eNB 20b supports the 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, other cells adjacent to the serving cell exist. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, the transmitter may be a part of the base station 20, and the receiver may be a part of the UE 10. In the uplink, the transmitter may be a part of the UE 10, and the receiver may be a part of the base station 20.

Meanwhile, a wireless communication system may be largely divided into a frequency division duplex (FDD) scheme and a time division duplex (TDD) scheme. According to the FDD scheme, uplink transmission and downlink transmission are performed while occupying different frequency bands. According to the TDD scheme, uplink transmission and downlink transmission are performed at different times while occupying the same frequency band. The channel response of the TDD scheme is substantially reciprocal. This means that the downlink channel response and the uplink channel response are almost the same in a given frequency domain. Accordingly, in the TDD-based radio communication system, there is an advantage that the downlink channel response can be obtained from the uplink channel response. In the TDD scheme, since uplink transmission and downlink transmission are time-divided in the entire frequency band, downlink transmission by the base station and uplink transmission by the UE cannot be performed simultaneously. In a TDD system in which uplink transmission and downlink transmission are divided in subframe units, uplink transmission and downlink transmission are performed in different subframes.

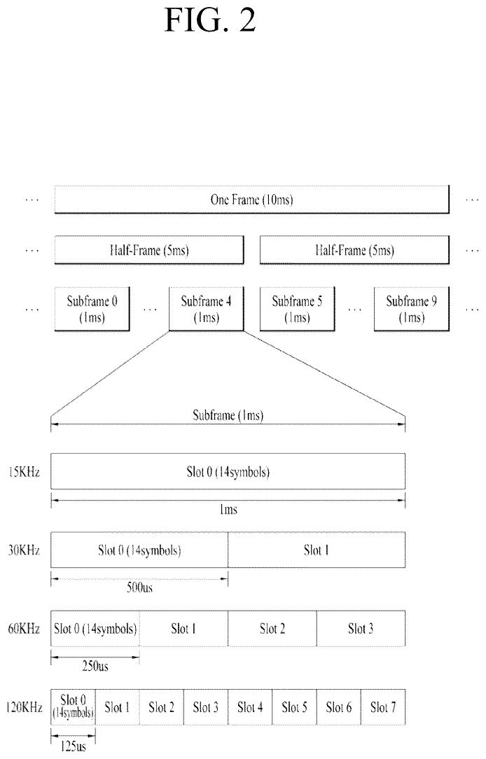

FIG. 2 illustrates a structure of a radio frame used in NR.

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on an SCS. Each slot includes 12 or 14 OFDM (A) symbols according to a CP. When a normal CP is used, each slot includes 14 OFDM symbols. When an extended CP is used, each slot includes 12 OFDM symbols. A symbol may include an OFDM symbol (CP-OFDM symbol) and an SC-FDMA symbol (or DFT-s-OFDM symbol).

### Support of Various Numerologies

With the development of wireless communication technology, multiple numerologies may be available to UEs in the NR system. For example, in the case where a subcarrier spacing (SCS) is 15 kHz, a wide area of the typical cellular bands is supported. In the case where an SCS is 30 kHz/60 kHz, a dense-urban, lower latency, wider carrier bandwidth is supported. In the case where the SCS is 60 kHz or higher, a bandwidth that is greater than 24.25 GHz is supported in order to overcome phase noise.

The numerologies may be defined by a cyclic prefix (CP) length and a subcarrier spacing (SCS). A single cell can provide a plurality of numerologies to UEs. When an index of a numerology is represented by μ, a subcarrier spacing and a corresponding CP length may be expressed as shown in the following table.

TABLE 2

| μ | Δf = 2^{μ} · 15 [kHz] | CP |
|---|---|---|
| 0 | 15 | normal |
| 1 | 30 | normal |
| 2 | 60 | normal, extended |
| 3 | 120 | normal |
| 4 | 240 | normal |
| 5 | 480 | normal |
| 6 | 960 | normal |

In the case of a normal CP, when an index of a numerology is expressed by μ, the number of OLDM symbols per slot N^{slot}_{symb}, the number of slots per frame N^{frame,μ}ₛₗₒₜ, and the number of slots per subframe N^{subframeμ}ₛₗₒₜ are expressed as shown in the following table.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

In the case of an extended CP, when an index of a numerology is represented by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz | 12 | 40 | 4 |
| | (u = 2) | | | |

In the NR system, OFDM (A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

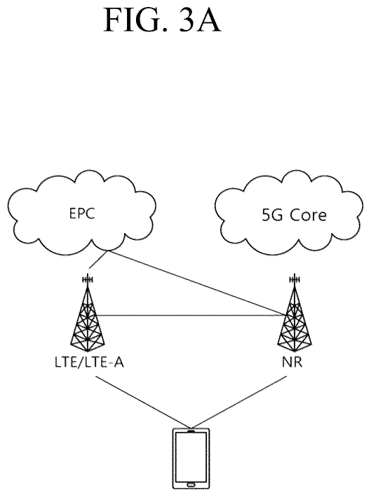

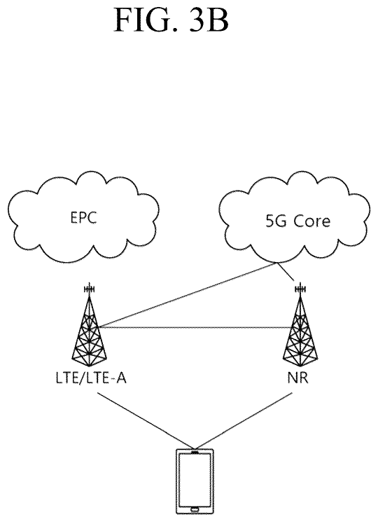

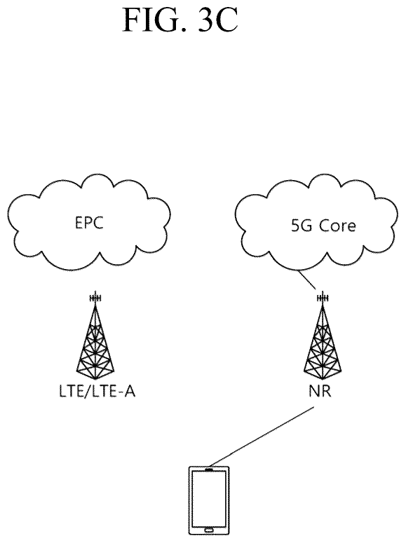

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 3B, the LTE/LTE-A cell is connected with a core network for 5th generation mobile communication, that is, a 5G core network, unlike the example in FIG. 3A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the above new radio access technology (NR), using a downlink subframe for reception from a base station and using an uplink subframe for transmission to the base station may be considered. This method may be applied to both paired and not-paired spectrums. A pair of spectrums indicates including two subcarriers for downlink and uplink operations. For example, one subcarrier in one pair of spectrums may include a pair of a downlink band and an uplink band.

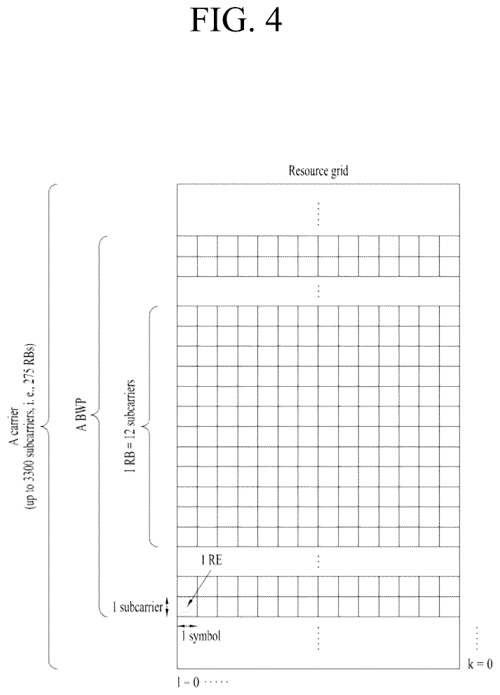

FIG. 4 illustrates a slot structure of an NR frame.

A slot includes a plurality of symbols in the time domain. For example, in the case of the normal CP, one slot includes seven symbols. On the other hand, in the case of an extended CP, one slot includes six symbols. A carrier includes a plurality of subcarriers in the frequency domain. A resource block (RB) is defined as consecutive subcarriers (e.g., 12 consecutive subcarriers) in the frequency domain. A bandwidth part (BWP) is defined as consecutive physical (P)RBs in the frequency domain and may correspond to one numerology (e.g., SCS, CP length, etc.). A UE may be configured with up to N (e.g., five) BWPs in both the downlink and the uplink. The downlink or uplink transmission is performed through an activated BWP, and only one BWP among the BWPs configured for the UE may be activated at any given time. In the resource grid, each element is referred to as a resource element (RE), and one complex symbol may be mapped to it.

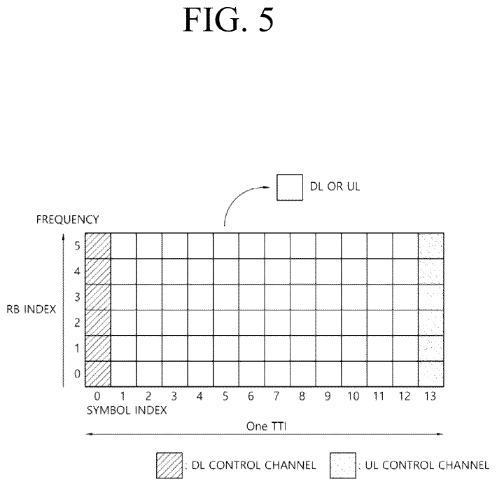

FIG. 5 shows an example of a subframe type in NR.

Referring to FIG. 5, a Transmission Time Interval (TTI) may be called a subframe or a slot for NR (or new RAT). The subframe (or slot) shown in FIG. 5 can be used in a TDD system of NR (or new RAT) to minimize data transmission delay. As shown in FIG. 5, a subframe (or slot) includes 14 symbols. The symbol at the head of the subframe (or slot) can be used for a DL control channel and the symbol at the end of the subframe (or slot) can be used for a UL control channel. The remaining symbols can be used for DL data transmission or UL data transmission. According to this subframe (or slot) structure, downlink transmission and uplink transmission can be sequentially performed in one subframe (or slot). Accordingly, downlink data can be received in a subframe (or slot) and uplink ACK/NACL may be transmitted in the subframe (or slot).

Such a subframe (or slot) structure may be called a self-contained subframe (or slot).

Specifically, the first N symbols (hereinafter referred to as the DL control region) in a slot may be used to transmit a DL control channel, and the last M symbols (hereinafter referred to as the UL control region) in the slot may be used to transmit a UL control channel. N and M are integers greater than 0. A resource region between the DL control region and the UL control region (hereinafter referred to as a data region) may be used for DL data transmission or UL data transmission. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

When this subframe (or slot) structure is used, a time taken to retransmit data that has failed in reception may be reduced to minimize final data transmission latency. In such a self-contained subframe (or slot) structure, a time gap may be required in a process of transition from a transmission mode to a reception mode or from the reception mode to the transmission mode. To this end, some OFDM symbols when DL switches to UL in the subframe structure can be configured to a guard period (GP).

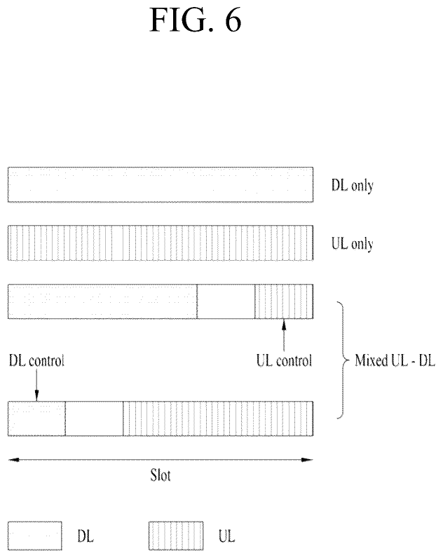

FIG. 6 illustrates a structure of a self-contained slot.

In the NR system, the frame has a self-contained structure, in which all of a DL control channel, DL or UL data channel, UL control channel, and other elements are included in one slot. For example, the first N symbols (hereinafter referred to as a DL control region) in a slot may be used for transmitting a DL control channel, and the last M symbols (hereinafter referred to as a UL control region) in the slot may be used for transmitting an UL control channel. N and M are integers greater than 0. A resource region between the DL control region and the UL control region (hereinafter referred to as a data region) may be used for DL data transmission or UL data transmission. For example, the following configurations may be taken into account. The durations are listed in temporal order.
1. DL only configuration
2. UL only configuration
3. Mixed UL-DL configuration
−DL region+Guard Period (GP)+UL control region
−DL control region+GP+UL region
DL region: (i) DL data region, (ii) DL control region+DL data region
UL region: (i) UL data region, (ii) UL data region+UL control region

A PDCCH may be transmitted in the DL control region, and a PDSCH may be transmitted in the DL data region. A PUCCH may be transmitted in the UL control region, and a PUSCH may be transmitted in the UL data region. In the PDCCH, Downlink Control Information (DCI), for example, DL data scheduling information or UL data scheduling data may be transmitted. In the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A GP provides a time gap during a process where a gNB and a UE transition from the transmission mode to the reception mode or a process where the gNB and UE transition from the reception mode to the transmission mode. Part of symbols belonging to the occasion in which the mode is changed from DL to UL within a subframe may be configured as the GP.

### Carrier Aggregation (CA)

The system frequency band of a wireless communication system is divided into a plurality of carrier frequencies. In the disclosure, the carrier frequency refers to the center frequency of a cell.

Hereinafter, a carrier aggregation system will be described.

The carrier aggregation system refers to the aggregation of multiple component carriers (CC). Through the carrier aggregation, the meaning of the existing cell may be changed. In the carrier aggregation, a cell may refer to a combination of a downlink component carrier and an uplink component carrier, or a single downlink (or uplink) component carrier.

Further, in the carrier aggregation, a serving cell may be divided into a primary cell and a secondary cell. The primary cell refers to a cell operating on a primary frequency, in which the UE either performs an initial connection establishment procedure or initiates the connection re-establishment procedure, or a cell indicated as the primary cell in a handover procedure. The secondary cell refers to a cell operating on a secondary frequency, which is used to provide additional radio resources once a radio resource control (RRC) connection is established.

The carrier aggregation system may support the cross-carrier scheduling. The cross-carrier scheduling refers to a scheduling method capable of performing resource allocation of a PDSCH transmitted by a different component carrier through a PDCCH transmitted through a specific CC and/or resource allocation of a PUSCH transmitted by another CC other than a CC primarily linked to the specific CC. That is, the PDCCH and the PDSCH may be transmitted through different DL CCs, and the PUSCH may be transmitted through a UL CC other than a UL CC linked to a DL CC on which a PDCCH including a UL grant is transmitted. In such a system of supporting the cross-carrier scheduling, a carrier indicator is required to indicate which DL CC/UL CC is used to transmit the PDSCH/PUSCH for which control information is provided through the PDCCH. Hereinafter, a field including the carrier indicator will be referred to as a carrier indication field (CIF).

The carrier aggregation system of supporting the cross-carrier scheduling may include the CIF in a typical DCI format. In the system of supporting the cross-carrier scheduling, for example, the LTE-A system, the existing DCI format (i.e., the DCI format used in LTE) may be extended by 3 bits because the CIF is added, and a PDCCH structure may reuse the existing coding method, the existing resource allocation method (i.e., CCE-based resource mapping), and so on.

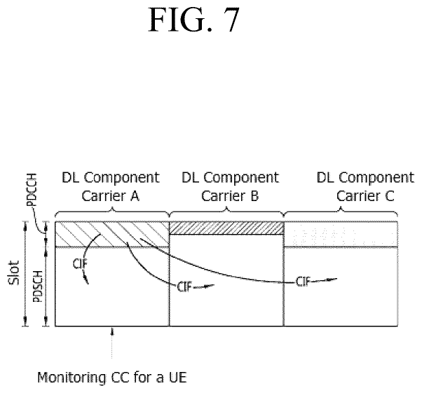

FIG. 7 illustrates cross-carrier scheduling in a carrier aggregation system.

Referring to FIG. 7, the base station may configure a PDCCH monitoring DL CC (monitoring CC) set. The PDCCH monitoring DL CC set consists of some DL CCs among all aggregated DL CCs. When cross-carrier scheduling is configured, a UE performs PDCCH monitoring/decoding only for the DL CC included in the PDCCH monitoring DL CC set. In other words, the base station uses only the DL CCs included in the PDCCH monitoring DL CC set to transmit the PDCCH for the PDSCH/PUSCH to be scheduled. The PDCCH monitoring DL CC set may be configured in a UE-specific, UE group-specific, or cell-specific manner.

FIG. 7 shows an example where three DL CCs (e.g., DL CC A, DL CC B, and DL CC C) are aggregated, and the DL CC A is configured as the PDCCH monitoring DL CC. The UE may receive scheduling information (i.e., the DCI including a DL grant) for the PDSCH of the DL CC A, DL CC B, and DL CC C through the PDCCH of the DL CC A. The DCI transmitted through the PDCCH of the DL CC A may include the CIF to indicate which DL CC the DCI is for.

### Dynamic Spectrum Sharing (DSS) Technology

The 5G wireless mobile communication system NR supports dynamic spectrum sharing (DSS), for example, frequency sharing technology for the coexistence with the LTE.

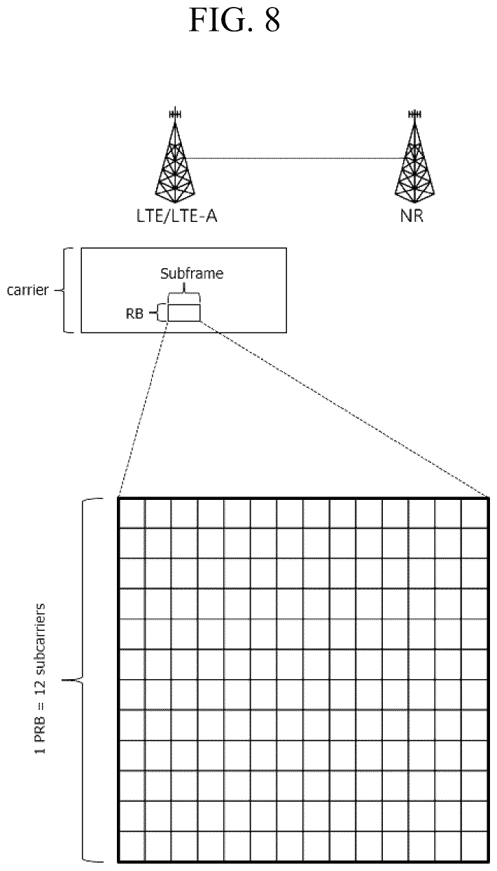

FIG. 8 shows an example of the DSS technology.

Referring to FIG. 8, carriers managed by an LTE/LTE-A base station may be dynamically shared by 5G NR base stations according to the DSS technology.

The LTE/LTE-A base station uses radio resources based on subcarrier spacing (SCS) of 15 kHz. In other words, one resource block (RB) defined in a frequency domain uses 12 subcarriers, and a transmission time interval (TTI) defined in a time domain uses a subframe.

In the DSS technology, the 5G NR-based system (i.e., gNB and terminal) uses the SCS of 15 kHz, which the LTE/LTE-A-based system (i.e., eNodeB and terminal) uses to define one RB in the frequency domain, as it is for the coexistence with the LTE/LTE-A-based system (i.e., eNodeB and terminal). The subframe, which the LTE/LTE-A-based system uses as the resource unit in the time domain, is used as one slot in the 5G NR system.

Meanwhile, in the LTE/LTE-A system, a cell-specific reference signal (CRS) is transmitted in the downlink. Hereinafter, the CRS will be described.

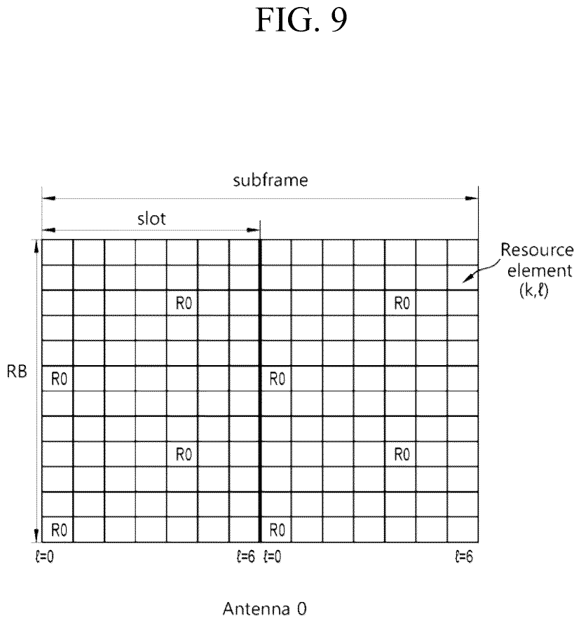

FIGS. 9 to 11 show some examples of a CRS structure when one or more antennas are used.

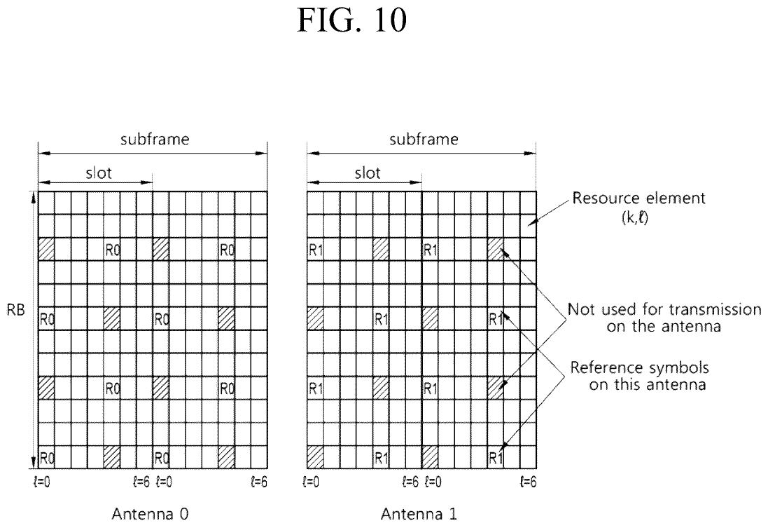

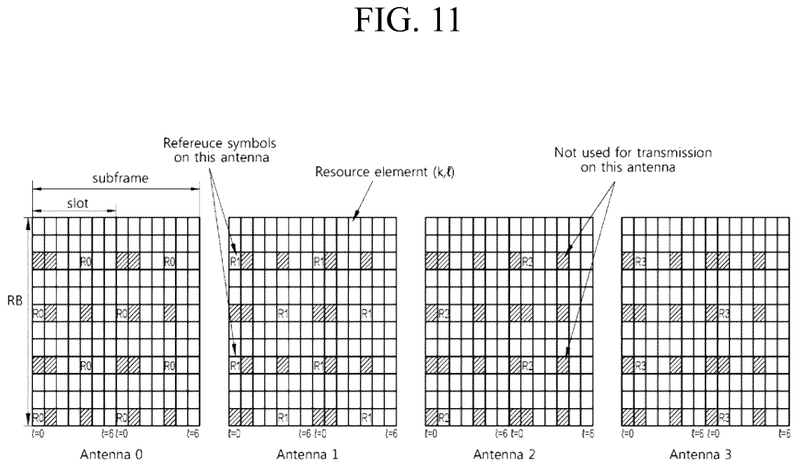

Specifically, FIG. 9 shows the CRS structure when the base station uses one antenna, FIG. 10 shows the CRS structure when the base station uses two antennas, and FIG. 11 shows the CRS structure when the base station uses 4 antennas.

Referring to FIGS. 9 to 11, in the case of multi-antenna transmission where the base station uses multiple antennas, one resource grid is present for each antenna. ‘R0’ represents a reference signal for a first antenna, ‘R1’ represents a reference signal for a second antenna, ‘R2’ represents a reference signal for a third antenna, and ‘R3’ represents a reference signal for a fourth antenna. The positions of R0 to R3 in the subframe do not overlap with each other. [symbol] represents a position of an OFDM symbol in the slot, and has values from 0 to 6 in the normal CP. In one OFDM symbol, the reference signal for each antenna is spaced by 6 subcarriers. In the subframe, the number of R0s is equal to the number of R1s, and the number of R2s is equal to the number of R3s. In the subframe, the number of R2s and R3s is smaller than the number of R0s and R1s. A resource element used for the reference signal of one antenna is not used for the reference signal of another antenna. This is to avoid interference between the antennas.

The CRS is always transmitted by the number of antennas irrespective of the number of streams. The CRS has an independent reference signal for each antenna. The frequency-domain position and the time-domain position of the CRS in a subframe are determined irrespective of a terminal. A CRS sequence to be multiplied to the CRS is generated independently of the terminal. Therefore, all terminals in a cell can receive the CRS. However, the position of the CRS in the subframe and the CRS sequence may be determined according to a cell identifier (ID). The time-domain position of the CRS in the subframe may be determined based on an antenna number and the number of OFDM symbols in a resource block. The frequency-domain position of the CRS in the subframe may be determined based on an antenna number, a cell ID, an OFDM symbol index [symbol] , a slot number in a radio frame, etc.

The CRS sequence may be applied in units of an OFDM symbol in one subframe. The CRS sequence may vary depending on a cell ID, a slot number in one radio frame, an OFDM symbol index in a slot, a CP type, etc. The number of reference signal subcarriers for each antenna on one OFDM symbol is 2. When a subframe includes N_{RB} resource blocks in a frequency domain, the number of RS subcarriers for each antenna on one OFDM symbol is 2×N_{RB}.

The CRS may be used in the LTE-A system to estimate channel state information (CSI). Based on the estimation of the CSI, channel quality indicator (CQI), a precoding matrix indicator (PMI), a rank indicator (RI), among others. may be reported from the terminal as necessary.

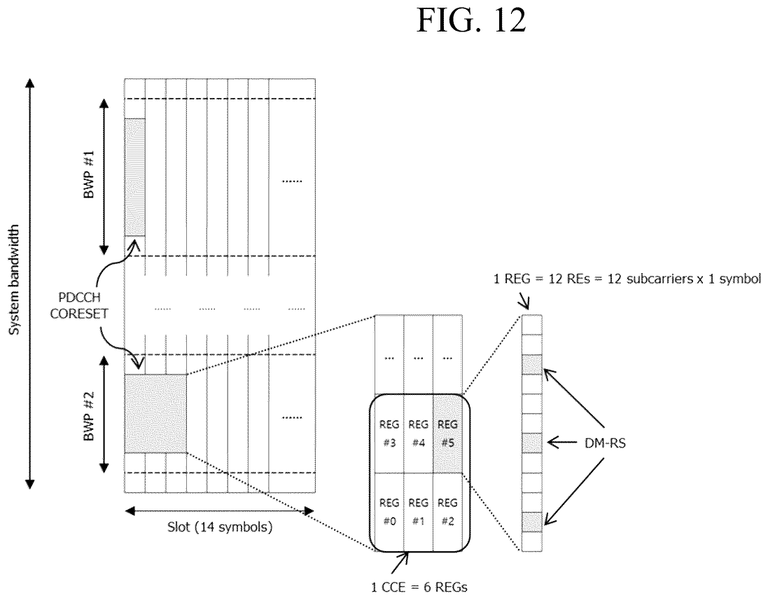

FIG. 12 shows an example of a 5G NR physical downlink control channel (PDCCH).

FIG. 12 illustrates that two BWPs (BWP #1, BWP #2) are configured within a system bandwidth in the frequency domain, and two PDCCH control resource sets (CORESET) are configured within one slot in the time domain. The CORESET may be allocated continuously or discontinuously in the frequency domain, and 1 to 3 OFDM symbols may be allocated in the time domain. Referring to the example shown in FIG. 12, one OFDM symbol is allocated to the PDCCH CORESET configured in the BWP #1, and three OFDM symbols are allocated to the PDCCH CORESET configured in the BWP #2.

Meanwhile, the PDCCH in 5G NR may be allocated in units of a control channel element (CCE). 1 CCE includes 6 resource element groups (REG), and 1 REG includes 12 resource elements (RE), which may also be defined as 1 physical resource block (PRB), i.e., 12 subcarriers in the frequency domain and 1 OFDM symbol in the time domain. The REG includes REs to which downlink control information (DCI) is mapped, and REs to which DM-RS for decoding it is mapped. As shown in FIG. 12, three DM-RSs may be configured within one REG.

### Problems to be Solved by the Disclosure of the Present Specification

The 5G wireless mobile communication system NR, defined in 3GPP, supports dynamic spectrum sharing (DSS), i.e., frequency sharing technology for the coexistence with LTE. In other words, as a method of efficiently migrating any LTE frequency band to be used as an NR frequency band in the future, it was defined to support the DSS technology for using all but the radio resources, which are used for transmitting an LTE signal, to transmit an NR signal in the corresponding frequency band. For example, any NR base station was defined to enable a rate match pattern configuration for the LTE CRS in order to transmit the PDSCH through all but resource elements (REs) used for transmitting the LTE CRS, when transmitting the PDSCH, i.e., the downlink data channel.

However, in the case of the PDCCH for transmitting the downlink control information (DCI) such as scheduling control information, it was defined to restrict NR PDCCH transmission for symbols where the LTE CRS transmission is performed. Therefore, NR PDCCH transmission is possible only through symbols #1 and #2 or through the symbol #2 based on the number of LTE CRS antenna ports among the first three symbols of any DL slot, such as symbols #0, #1, and #2. Specifically, NR PDCCH transmission is possible through symbol #1 and symbol #2 when the number of LTE CRS antenna ports is 1 or 2, and the NR PDCCH transmission is possible only through the symbol #2 when the number of LTE CRS antenna ports is 4.

Such a limitation of the OFDM symbols capable of NR PDCCH transmission may cause a lack of NR PDCCH capacity. To solve this, there is an increasing need for technology to support NR PDCCH transmission even in the OFDM symbols used for LTE CRS transmission.

Therefore, the disclosure introduces a method of supporting NR PDCCH transmission in a symbol where LTE CRS transmission is performed. In particular, the disclosure provides a method of configuring a rate matching for the LTE CRS when the radio resources allocated for the NR PDCCH transmission include that LTE CRS, and a method of solving an overlap between the RE(s) where the DM-RS transmission is performed for demodulation of the NR PDCCH and the RE(s) where the LTE CRS transmission is performed.

### Point 1: LTE CRS Rate Matching Configuration

When the base station transmits the NR PDCCH and the terminal monitors and receives the NR PDCCH, the RE(s) used for the LTE CRS transmission is defined as not transmitting or receiving a PDCCH payload or PDCCH DM-RS, which may be configured by the base station.

To support DSS, a NR base station transmits LTE CRS rate matching pattern configuration information for the NR PDSCH to a terminal in the corresponding cell through the RRC signaling. In other words, RRC information element (IE) “RateMatchPatternLTE-CRS” was defined to transmit the LTE CRS rate matching configuration information for the NR PDSCH, and the corresponding RRC IE was defined to include information as shown in Tables 5 and 6. Therefore, an NR terminal does not expect the NR PDSCH reception for the RE(s) used for the corresponding LTE CRS transmission, when receiving the NR PDSCH. Likewise, the rate matching may be defined to be performed even for the NR PDCCH reception based on the “RateMatchPatternLTE-CRS.”

### RateMatchPatternLTE-CRS Information Element

TABLE 5
ASN1START
-- TAG-RATEMATCHPATTERNLTE-CRS-START

| | |
|---|---|
| RateMatchPatternLTE-CRS : := | SEQUENCE { |
| carrierfreqDL | INTEGER (0..16383), |
| carrierBandwidthDL | ENUMERATED {n6, n15, |
| | n25, n50, |
| n75, n100, spare2. spare1}, | |
| mbsfn-SubframeConfigList | EUTRA-MBSFN- |
| | SubframeConfigList |
| OPTIONAL, -- Need N | |
| nrofCRS-Ports | ENUMERATED {n1, n2, n4}, |
| v-Shift | ENUMERATED {n0, n1, n2, n3, n4, |
| n5} | |
| } | |
| LTE-CRS-ParternList-r16 : := | SEQUENCE (SIZE (1..maxLTE-CRS- |

Patterns-r16)) OF RateMatchPatternLTE-CRS
-- TAG-RATEMATCHPATTERNLTE-CRS-STOP
ASN1STOP

TABLE 6
RateMatchPatternLTE-CRS field descriptions

carrierBandwidthDL
BW of the LTE carrier in number of PRBs (see TS 38.214 [19],
clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19],
clause 5.1.4.2).
nrofCRS-Ports
Number of LTE CRS antenna port to rate-match around
(see TS 38.214 [19], clause 5.1.4.2).
v-Shift
Shifting value v-shift in LTE to rate match around LTE CRS
(see TS 38.214 [19], clause 5.1.4.2).

According to embodiments in the disclosure, the LTE CRS rate matching configuration for the NR PDCCH may be performed in units of a CORESET or a search space, in order to apply the LTE CRS rate matching to that NR PDCCH. In other words, when the CORESET is configured for a terminal in the NR base station, it may be defined to include indication information for applying the NR PDCCH rate matching based on the corresponding “RateMatchPatternLTE-CRS.” Specifically, an information region indicating whether to apply the LTE CRS rate matching based on the “RateMatchPatternLTE-CRS” is defined in the RRC IE to configure the CORESET for a terminal, and it is determined based on this information region whether to apply the LTE CRS rate matching to the NR PDCCH transmitted through that CORESET. Alternatively, the corresponding CORESET configuration information may be defined to directly include carrierFreqDL, carrierBandwidthDL, mbsfn-SubframeConfigList, and the like information included in the “RateMatchPatternLTE-CRS,” so that LTE CRS rate matching for the NR PDCCH can be performed. Alternatively, when the search space for a terminal is configured in the NR base station, it may be defined to include the indication information for applying the NR PDCCH rate matching based on “RateMatchPatternLTE-CRS.” Specifically, the information region indicating whether to apply the CRS rate matching based on the “RateMatchPatternLTE-CRS” configuration is defined in the RRC IE for configuring the search space for a terminal, and it is thus determined based on the information region whether to apply the LTE CRS rate matching for the NR PDCCH transmitted through that search space. Alternatively, the search space configuration information may be defined to directly include carrierFreqDL, carrierBandwidthDL, mbsfn-SubframeConfigList and the like information included in the “RateMatchPatternLTE-CRS,” so that the LTE CRS rate matching can be performed based on this. As another method of applying the LTE CRS rate matching for the NR PDCCH, it may be defined to determine whether to apply the LTE CRS rate matching for the NR PDCCH in units of the terminal.

For example, a terminal may implicitly determine whether to apply the LTE CRS rate matching for the NR PDCCH based on UE capability configuration information and the “RateMatchPatternLTE-CRS” configuration. Specifically, the base station and the UE may exchange information about whether the corresponding UE supports the LTE CRS rate matching for the NR PDCCH through UE capability configuration information. Based on this information exchange, it is determined whether a terminal supports the LTE CRS rate matching for the NR PDCCH. In this case, when a terminal supports the LTE CRS rate matching for the NR PDCCH, the LTE CRS rate matching for the NR PDCCH is determined based on whether the “RateMatchPatternLTE-CRS” is configured. In other words, in case where the terminal is configured with any LTE CRS pattern information through the reception of the “RateMatchPatternLTE-CRS,” the terminal may assume the rate matching for the LTE CRS RE(s) when receiving the NR PDCCH based on that information. In other words, when the NR PDCCH transmission for the terminal includes the RE(s) where the LTE CRS transmission is performed based on the “RateMatchPatternLTE-CRS,” the NR PDCCH transmission may be performed with the rate matching for the RE(s) where the LTE CRS transmission is performed.

Alternatively, additional information region may be defined in that “RateMatchPatternLTE-CRS” to indicate whether the rate matching is configured for the NR PDCCH, so that the base station can explicitly perform signaling whether to apply the LTE CRS rate matching for the NR PDCCH through that information region. Therefore, for a terminal supporting the LTE CRS rate matching for the NR PDCCH, the base station may transmit the NR PDCCH for that terminal, which additionally includes the explicit configuration information about whether to apply the LTE CRS rate matching based on the “RateMatchPatternLTE-CRS” configuration, to that terminal. The terminal may determine whether to apply the rate matching for the LTE CRS when receiving the NR PDCCH based on the configured “RateMatchPatternLTE-CRS” from the base station.

### Point 2: PDCCH DM-RS Collision Handling

The CORESET for the PDCCH transmission for any NR terminal may be configured for up to 3 symbols in the time domain. Thus, the CORESET for the PDCCH transmission including PDSCH/PUSCH scheduling control information based on any mapping type A may be configured up to the first three symbols of any NR slot in the time domain.

The DM-RS for the NR PDCCH transmission in the frequency domain is transmitted through three subcarriers, of which subcarrier indices are #1, #5, and #9, among twelve subcarriers, of which subcarrier indices are #0 to #11, constituting any one PRB as shown in the following Tables 5 to 7.

On the other hand, the LTE CRS is transmitted through the first OFDM symbol when the number of antenna ports is 1 or 2; is transmitted through the first and second OFDM symbols when the number of antenna ports is 4; and, in the frequency domain, is transmitted through the subcarriers #0 and #6 when the number of antenna ports is 1; and is transmitted through the subcarriers #0, #3, #6 and #9 when the number of antenna ports is 2 or 4. However, in the case of the frequency domain, the LTE CRS is transmitted with a shift in the frequency domain based on vshift values of physical cell ID (PCID).

When the NR PDCCH and the LTE CRS are transmitted through the same symbol within one PRB, cases where a collision occurs between the NR PDCCH DM-RS and the LTE CRS are shown in the following Tables 7 to 9 according to LTE CRS antenna port numbers. Specifically, the Tables 7 to 8 show collision cases based on the vshift values when the LTE CRS antenna port number is 1, and the Table 9 shows a collision case based on the vshift values when the LTE CRS antenna port number is 2 or 4.

TABLE 7

| | | RE(s) | | | RE(s) | | | RE(s) |
|---|---|---|---|---|---|---|---|---|
| Subcarrier | RE(s) for | for | Subcarrier | RE(s) for | for | Subcarrier | RE(s) for | for |
| index | NR PDCCH | LTE | index | NRP DCCH | LTE | index | NR PDCCH | LTE |
| in a PRB | DM-RS | CRS | in a PRB | DM-RS | CRS | in a PRB | DM-RS | CRS |
| 11 | | | 11 | | | 11 | | |
| 10 | | | 10 | | | 10 | | |
| 9 | NR-DMRS | | 9 | NR-DMRS | | 9 | NR-DMRS | |
| 8 | | | 8 | | | 8 | | port 0 |
| 7 | | | 7 | | port 0 | 7 | | |
| 6 | | port 0 | 6 | | | 6 | | |
| 5 | NR-DMRS | | 5 | NR-DMRS | | 5 | NR-DMRS | |
| 4 | | | 4 | | | 4 | | |
| 3 | | | 3 | | | 3 | | |
| 2 | | | 2 | | | 2 | | port 0 |

TABLE 8

| | | RE(s) | | | RE(s) | | | RE(s) |
|---|---|---|---|---|---|---|---|---|
| Subcarrier | RE(s) for | for | Subcarrier | RE(s) for | for | Subcarrier | RE(s) for | for |
| index | NR PDCCH | LTE | index | NR PDCCH | LTE | index | NR PDCCH | LTE |
| in a PRB | DM-RS | CRS | in a PRB | DM-RS | CRS | in a PRB | DM-RS | CRS |
| 11 | | | 11 | | | 11 | | port 0 |
| 10 | | | 10 | | port 0 | 10 | | |
| 9 | NR-DMRS | port 0 | 9 | NR-DMRS | | 9 | NR-DMRS | |
| 8 | | | 8 | | | 8 | | |
| 7 | | | 7 | | | 7 | | |
| 6 | | | 6 | | | 6 | | |
| 5 | NR-DMRS | | 5 | NR-DMRS | | 5 | NR-DMRS | port 0 |
| 4 | | | 4 | | port 0 | 4 | | |
| 3 | | port 0 | 3 | | | 3 | | |
| 2 | | | 2 | | | 2 | | |
| 1 | NR-DMRS | | 1 | NR-DMRS | | 1 | NR-DMRS | |
| 0 | | | 0 | | | 0 | | |

TABLE 9

| | | RE(s) | | | RE(s) | | | RE(s) |
|---|---|---|---|---|---|---|---|---|
| Subcarrier | RE(s) for | for | Subcarrier | RE(s) for | for | Subcarrier | RE(s) for | for |
| index | NR PDCCH | LTE | index | NR PDCCH | LTE | index | NR PDCCH | LTE |
| in a PRB | DM-RS | CRS | in a PRB | DM-RS | CRS | in a PRB | DM-RS | CRS |
| 11 | | | 11 | | | 11 | | port 1 or 3 |
| 10 | | | 10 | | port 1 or 3 | 10 | | |
| 9 | NR-DMRS | port 1 or 3 | 9 | NR-DMRS | | 9 | NR-DMRS | |
| 8 | | | 8 | | | 8 | | port 0 or 2 |
| 7 | | | 7 | | port 0 or 2 | 7 | | |
| 6 | | port 0 or 2 | 6 | | | 6 | | |
| 5 | NR-DMRS | | 5 | NR-DMRS | | 5 | NR-DMRS | port 1 or 3 |
| 4 | | | 4 | | port 1 or 3 | 4 | | |
| 3 | | port 1 or 3 | 3 | | | 3 | | |
| 2 | | | 2 | | | 2 | | port 0 or 2 |
| 1 | NR-DMRS | | 1 | NR-DMRS | port 0 or 2 | 1 | NR-DMRS | |
| 0 | | port 0 or 2 | 0 | | | 0 | | |

As shown in the foregoing Tables 7 to 9, there are various cases where the collision occurs between the NR PDCCH DM-RS and the LTE CRS according to the LTE CRS antenna port numbers (=1, 2, or 4) during the first three symbols of any DL slot.

### I. First Disclosure: NR PDCCH DM-RS Shifting Scheme in Frequency Domain

When the RE(s) allocated for the NR PDCCH DM-RS transmission overlaps with the LTE CRS RE(s), the NR PDCCH DM-RS transmitted through the RE corresponding to that overlap may be shifted in the frequency domain.

In this case, a first method of frequency shifting for the DM-RS may be defined to shift only the RE of the subcarrier, where the collision with the LTE CRS has occurred, among the DM-RSs transmitted through the subcarriers #1, #5, and #9 of each PRB in any symbol, by 1 in a positive direction in the frequency domain. In other words, if the subcarrier index of the subcarrier where the overlap has occurred between the DM-RS and the CRS is N, the DM-RS to be transmitted through the subcarrier #N may be transmitted through the subcarrier #N+1. Specifically, the NR PDCCH DM-RS transmission is performed through the subcarriers #1, #5, and #9 in one PRB. In this case, when the collision with the LTE CRS transmission occurs in the subcarrier #1, only the DM-RS to be transmitted through the subcarrier #1 may be shifted and transmitted through the subcarrier #2. In this case, the DM-RS is transmitted through the subcarriers, of which the subcarrier indices are #2, #5 and #9, in the PRB of each NR DM-RS in the corresponding symbol. Even when the collision with the LTE CRS occurs in the remaining subcarrier #5 or #9, only the DM-RS to be transmitted through the corresponding subcarrier may be shifted to 1 subcarrier in the positive direction in the same way. In other words, as a shifted DM-RS pattern in any PRB, the sets of subcarrier indices corresponding to the DM-RS transmission in that PRB may be defined as (#2, #5, #9), (#1, #6, #9), and (#1, #5, #10), respectively.

A second method of frequency shifting for the DM-RS may be defined to shift only the RE of the subcarrier, where the collision with the LTE CRS has occurred, among the DM-RSs transmitted through the subcarriers #1, #5, and #9 of each PRB in any symbol, by 1 in a negative direction in the frequency domain. In other words, if the subcarrier index of the subcarrier where the overlap has occurred between the DM-RS and the CRS is N, the DM-RS may be transmitted through the subcarrier #N−1 of which the subcarrier index is #N−1. Specifically, the NR PDCCH DM-RS transmission is performed through the subcarriers, of which the subcarrier indices are #1, #5, and #9, in one PRB. In this case, when the collision with the LTE CRS transmission occurs in the subcarrier #1, only the DM-RS to be transmitted through that subcarrier #1 may be shifted and transmitted through the subcarrier #0. In this case, the NR DM-RS in the corresponding symbol is transmitted through the subcarriers, of which the subcarrier indices are #0, #5 and #9, in each PRB. Even when the collision with the LTE CRS occurs in the remaining subcarrier #5 or #9, only the DM-RS to be transmitted through the corresponding subcarrier may be shifted by 1 subcarrier in the negative direction in the same way. In other words, as a shifted DM-RS pattern in any PRB, the sets of subcarrier indices corresponding to the DM-RS transmission in that PRB may be defined as (#0, #5, #9), (#1, #4, #9), and (#1, #5, #8), respectively.

A third method of frequency shifting for the DM-RS may be defined to perform shifting in the frequency domain when the LTE CRS antenna port number is 1 and the collision with the LTE CRS occurs in any subcarrier, not only the subcarrier of the corresponding DM-RS RE but also all the DM-RS REs within the corresponding PRB. In other words, when the vshift values of the LTE CRS in the foregoing Tables 5 to 6 are 1, 3 and 5, respectively, the collisions occur in the subcarriers #1, #5, and #9, respectively. In this case, the NR DM-RS in that symbol may be shifted in the positive direction so as to be transmitted through the subcarriers #2, #6, and #10, or be shifted in the negative direction so as to be transmitted through the subcarriers #0, #4, and #8.

To apply the frequency shifting (i.e., subcarrier shifting) for the foregoing NR PDCCH DM-RS, the base station may be defined to make the terminal newly include frequency information for the LTE CRS transmission (e.g. carrierFreqDL information, carrierBandwidthDL information, etc.) and LTE CRS antenna port number information (i.e., nrofCRS-Ports information, etc.) and vshift information when any CORESET is configured. Based on this, any NR terminal obtains information about the REs, where the LTE CRS transmission is performed, and apply one DM-RS shifting pattern among various DM-RS shifting patterns described above, when the LTE CRS transmission is expected in any NR PDCCH DM-RS RE(s). In this case, the shifting pattern to be applied may be defined as one of the foregoing schemes. In other words, the same shifting scheme may be defined to be applied to all the collision cases between the DM-RS and the CRS shown in the foregoing Tables 5 to 7. Alternatively, a separate shifting scheme may be defined to be applied for each collision case. For example, the foregoing third scheme may be defined to be applied to the case where the LTE CRS antenna port number is 1 (i.e., the case of the Tables 5 to 6), and the foregoing first or second scheme may be defined to be applied to the case where the LTE CRS antenna port number is 2 or 4. In other words, the NR PDCCH DM-RS shifting pattern may be defined to be mapped for each collision case.

Alternatively, the base station may be defined to directly configure the corresponding DM-RS shifting pattern information through higher layer signaling. For example, it may be defined to additionally include the DM-RS shifting pattern information in the foregoing CORESET configuration information.

### II. Second Disclosure: NR PDCCH DM-RS Shifting Scheme in Time Domain

The NR -PDCCH DM-RS transmission symbol may be defined to be shifted when a collision between the NR PDCCH DM-RS transmission and the LTE CRS transmission occurs in one or more RE(s) for the RE(s) allocated for the NR PDCCH DM-RS in any symbol. Specifically, a collision may occur between the NR PDCCHDM-RS and the LTE CRS in one symbol or two symbols according to the duration of CORESET (the number of symbols for CORESET) and the LTE CRS antenna port numbers. In this case, the PDCCH DM-RS transmission symbol of the CORESET may be defined to be shifted by the number of symbols.

For example, when the CORESET duration is set to 3 (i.e., the PDCCH transmission is performed through the first three symbols of any slot), and the number of CRS port is 2, the collision may occur between the NR PDCCH DM-RS and the LTE CRS in the first symbol. In this case, the NR PDCCH DM-RSs transmitted through the first, second and third symbols are shifted by 1 symbol and transmitted through the second, third, and fourth symbols, respectively.

However, time domain shifting may be limited within the configured CORESET duration. For example, when time shifting within the corresponding CORESET duration is limited under the conditions that the CORESET duration is set to 3 and the LTE CRS port number is 2, it may be defined to transmit the NR PDCCH DM-RS through the second symbol and the third symbol except the first symbol where a collision occurs between the NR PDCCH DM-RS and the LTE CRS rather than shifting the NR PDCCH DM-RS. In other words, the NR PDCCH DM-RS may be defined to be transmitted through only the symbols other than the symbol where the LTE CRS transmission is performed, while the existing pattern is maintained in the existing frequency domain.

### III. Third Disclosure: NR PDCCH DM-RS Puncturing Scheme

When the LTE CRS transmission is performed for the RE(s) allocated to the NR PDCCH DM-RS transmission in any symbol, that RE(s) may be defined to puncture the NR PDCCH DM-RS. Within one PRB, the NR PDCCH DM-RS is transmitted through the subcarriers #1, #5, and #9. However, as shown in the Tables 5 to 7, a collision may occur between the DM-RS transmission and the LTE CRS transmission in one symbol or two symbols according to the number of LTE CRS ports. In this case, the REs where the LTE CRS transmission is performed may be defined not to perform the NR PDCCH DM-RS transmission, in other words, puncture the DM-RS transmission. For example, when a collision with the LTE CRS transmission occurs in the subcarrier #1, the NR PDCCH DM-RS may be defined to be transmitted only through the subcarriers #5 and #9.

Even in this case, like the frequency shifting according to the foregoing scheme of the first disclosure, to apply the frequency shifting (i.e., subcarrier shifting) for the foregoing NR PDCCH DM-RS, the base station may be defined to make the terminal newly include frequency information for the LTE CRS transmission (e.g. carrierFreqDL information, carrierBandwidthDL information, etc.) and LTE CRS antenna port number information (i.e., nrofCRS-Ports information, etc.) and vshift information when any CORESET is configured. Based on this, any NR terminal obtains information about the REs, where the LTE CRS transmission is performed, and puncture the DM-RS transmission in any NR PDCCH DM-RS RE(s) when the LTE CRS transmission is expected in that RE(s). Alternatively, a punctured DM-RS pattern may be defined to be directly indicated through higher layer signaling. For example, a punctured DM-RS pattern for the subcarrier #1 or a punctured DM-RS for the subcarrier #5 and the subcarrier #9 may be defined to signal the information about this directly to the terminal.

In addition, the base station may directly configure/indicate or implicitly configure (e.g., select) a method to be applied among the foregoing methods (frequency domain shifting, time domain shifting, and puncturing) described in the first to third disclosures. For example, the base station may be defined to signal the method to be applied among the foregoing method to the terminal. In other words, cell-specific or UE-specific CORESET configuration information may be defined to include a PDCCH candidate configured through the corresponding CORESET, and DM-RS transmission configuration information about the PDCCH transmitted therethrough. Alternatively, it may be implicitly defined to apply the NR PDCCH DM-RS shifting or puncturing according to the density of the DM-RS. In other words, it may be defined to determine whether to apply the puncturing or the shifting according to the number of symbols (1 symbol or 2 symbols) where a collision with the LTE CRS occurs and the duration of the CORESET. Alternatively, it may be defined to derive a method of transmitting the PDCCH DM-RS based on the presence of the symbol where the LTE CRS is not included, a proportion of the symbols including the LTE CRS within the entire CORESET duration, or etc. In other words, every collision case described above may be defined to be mapped and applied with the frequency domain shifting, time domain shifting, or puncturing scheme.

Here, the corresponding NR PDCCH DM-RS transmission method configuration/indication information has been described from a base station perspective. From a terminal perspective, this may be defined by the NR PDCCH DM-RS reception method configuration/indication information or the NR PDCCH channel estimation method configuration/indication information region thereof. However, in the case of the punctured DM-RS according to the foregoing method of the third disclosure, configuration/indication information about whether to transmit the punctured DM-RS to the terminal may not be separately defined. In this case, the base station may puncture the NR PDCCH DM-RS transmission in the RE overlapping the LTE CRS, or the terminal may follow the existing NR PDCCH channel estimation or perform the punctured DM-RS-based channel estimation.

For example, the time shifting method described in the second disclosure and the puncturing method described in the third disclosure may be applied. When any CORESET is configured, the base station may be defined to transmit the corresponding configuration information to the terminal or may be defined to indicate the corresponding DM-RS transmission scheme through MAC CE signaling for any CORESET. Alternatively, it may be defined to include the configuration information about the channel estimation of the terminal based on the corresponding DM-RS transmission. In other words, according to the foregoing method of the second disclosure, the configuration information may be included to perform the channel estimation only for the DM-RS REs of the symbol that does not overlap the symbol where the LTE CRS transmission is performed, or according to the foregoing method of the third disclosure, the configuration information may be included to perform the channel estimation using the existing DM-RS REs in all the symbols including all the symbols where the LTE CRS transmission is performed. Alternatively, according to an implicit method based on whether any CORESET or PDCCH transmission includes the symbol where the LTE CRS transmission is not performed, it may be defined to determine whether to perform the channel estimation based on only the DM-RS REs of the symbols where the LTE CRS transmission is not included according to the foregoing scheme of the second disclosure, or whether to perform the channel estimation based on the existing NR PDCCH DM-RS REs.

Further, the signaling from the base station to the terminal according to the disclosure may include explicit signaling to the terminal, such as higher layer signaling, medium access control (MAC) control element (CE) signaling, or layer 1 (L1) control signaling, or implicit signaling. Here, the higher layer signaling refers to RRC signaling where the transmission is performed through the PDSCH, which includes UE-specific, cell-specific or UE-group common RRC signaling. The L1 control signaling refers to DCI transmitted through the PDCCH, which may include UE-specific DCI, UE-group common DCI, or cell-specific DCI. The implicit signaling may include a case where the configuration is determined based on the configuration of other information.

### Embodiments of the Present Specification

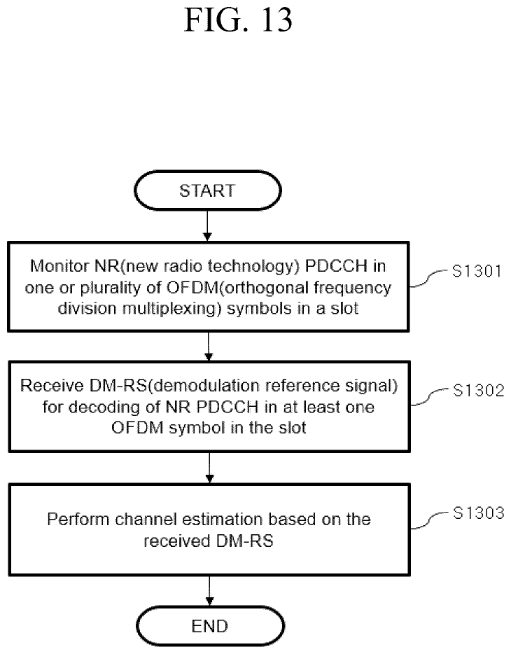

FIG. 13 illustrates an operation method of a terminal according to an embodiment of the present specification.

Referring to FIG. 13, a terminal performs monitoring of a new radio technology (NR) PDCCH in one orthogonal frequency division multiplexing (OFDM) symbol or a plurality of OFDM symbols within a slot (S1301). Here, the slot is used for a long term evolution (LTE) cell-specific reference signal (CRS).

Meanwhile, the terminal receives a demodulation reference signal (DM-RS) of the NR PDCCH in at least one OFDM symbol within the slot (S1302), in which a resource element (RE) used for the DM-RS for decoding of the NR PDCCH does not overlap with the RE used for the LTE CRS.

Then, the terminal performs channel estimation based on the received DM-RS (S1303).

The at least one OFDM symbol that receives the DM-RS for the decoding of the NR PDCCH described above may include an OFDM symbol where the LTE CRS is not included. Further, DM-RS puncturing may be applied to the RE used for the LTE CRS.

Meanwhile, although not shown in FIG. 13, the terminal may receive LTE CRS configuration information from the base station through a radio resource control (RRC) signaling before monitoring the NR PDCCH in a single OFDM symbol or multiple OFDM symbols within the slot. Here, the LTE CRS configuration information may be rate matching pattern configuration information of the LTE CRS for the NR PDCCH.

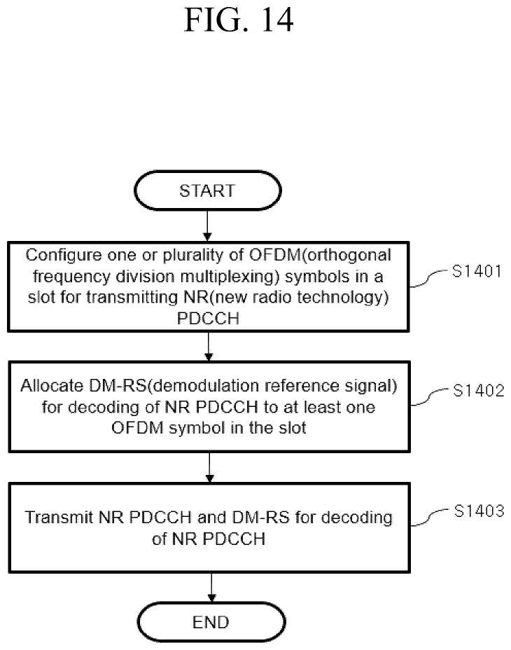

FIG. 14 illustrates an operation method of a base station according to an embodiment of the present specification.

Referring to FIG. 14, the base station configures a single orthogonal frequency division multiplexing (OFDM) symbol or multiple OFDM symbols within a slot to transmit new radio technology (NR) PDCCH (S1401). Here, the slot is used for a long term evolution (LTE) cell-specific reference signal (CRS).

Further, the base station allocates a demodulation reference signal (DM-RS) for decoding of the NR PDCCH to at least one OFDM symbol within the slot (S1402).

Then, the base station transmits the NR PDCCH and the DM-RS for the decoding of the NR PDCCH to the terminal (S1403), in which a resource element (RE) used for the DM-RS for the decoding of the NR PDCCH does not overlap with the RE used for the LTE CRS.

The at least one OFDM symbol that allocates the DM-RS for the decoding of the NR PDCCH described above may include an OFDM symbol where the LTE CRS is not included. Further, DM-RS puncturing may be applied to the RE used for the LTE CRS.

Meanwhile, although not shown in FIG. 14, the base station may transmit LTE CRS configuration information to the terminal through a radio resource control (RRC) signaling before transmitting the NR PDCCH and the DM-RS for the decoding of the NR PDCCH. Here, the LTE CRS configuration information may be rate matching pattern configuration information of the LTE CRS for the NR PDCCH.

### IV. Apparatuses to Which the Disclosure is Applicable

The embodiments described up to now may be implemented through various means. For example, the embodiments may be implemented by hardware, firmware, software, or a combination thereof. Details will be described with reference to the accompanying drawings.

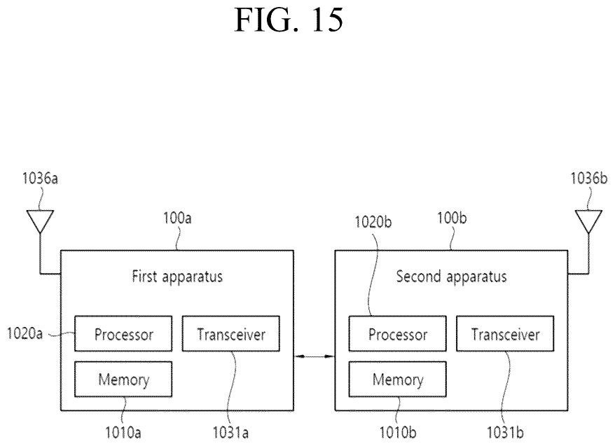

FIG. 15 shows apparatuses according to an embodiment of the disclosure.

Referring to FIG. 15, a wireless communication system may include a first apparatus 100a and a second apparatus 100b.

The first apparatus 100a may include a base station, a network node, a transmission user equipment (UE), a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may perform the foregoing functions, procedures, and/or methods. The processor 1020a may implement one or more protocols. For example, the processor 1020a may perform one or more layers of a radio interface protocol. The memory 1010a may be connected to the processor 1020a, and configured to various types of information and/or instructions. The transceiver 1031a may be connected to the processor 1020a, and controlled to transceive a radio signal.

The second apparatus 100b may include at least one processor such as a processor 1020b, at least one memory device such as a memory 1010b, and at least one transceiver such as a transceiver 1031b. The processor 1020b may perform the foregoing functions, procedures, and/or methods. The processor 1020b may implement one or more protocols. For example, the processor 1020b may implement one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b, and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

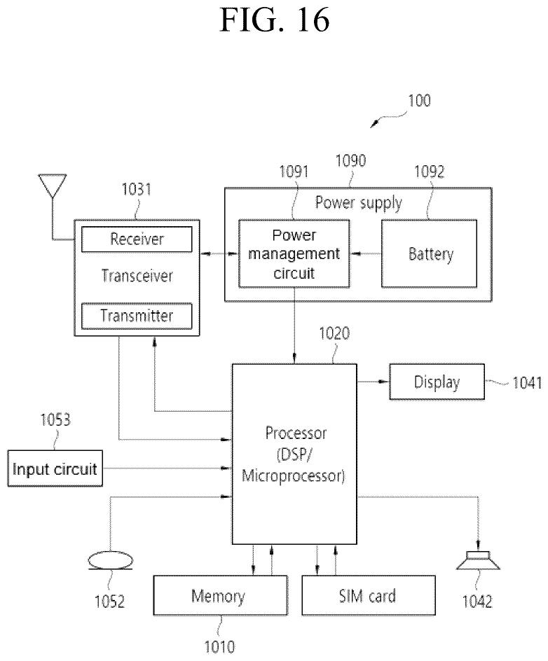

FIG. 16 is a block diagram showing a configuration of a terminal according to an embodiment of the disclosure.

In particular, FIG. 16 illustrates the foregoing apparatus of FIG. 15 in more detail.

The apparatus includes a memory 1010, a processor 1020, a transceiver 1031, a power management circuit 1091, a battery 1092, a display 1041, an input circuit 1053, a loudspeaker 1042, a microphone 1052, a subscriber identification module (SIM) card, and one or more antennas.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management circuit 1091 manages a power for the processor 1020 and/or the transceiver 1031. The battery 1092 supplies power to the power management module 1091. The display 1041 outputs the result processed by the processor 1020. The input circuit 1053 receives an input to be used by the processor 1020. The input unit 1053 may be displayed on the display 1041. The SIM card is an integrated circuit used to safely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

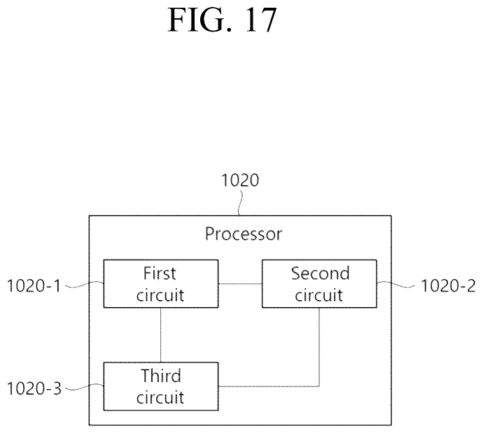

FIG. 17 is a configuration block diagram of a processor in which the disclosure is implemented.

As can be seen with reference to FIG. 17, a processor 1020 in which the disclosure of the present specification is implemented may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP), and may include at least one of a digital signal processor (DSP), a central processing unit (CPU), and a graphics processing unit (GPU).

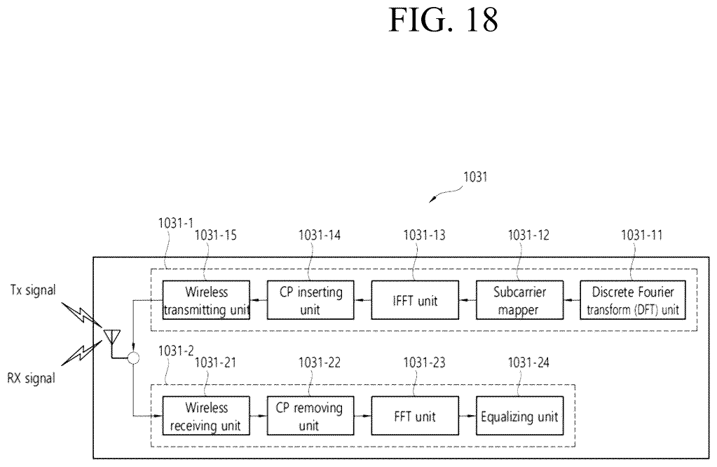

FIG. 18 is a detailed block diagram of a transceiver of a first apparatus shown in FIG. 15 or a transceiving unit of an apparatus shown in FIG. 16.

Referring to FIG. 18, the transceiving unit 1031 includes a transmitter 1031-1 and a receiver 1031-2. The transmitter 1031-1 includes a discrete Fourier transform (DFT) unit 1031-11, a subcarrier mapper 1031-12, an IFFT unit 1031-13, a cyclic prefix (CP) insertion unit 1031-14, and a wireless transmitting unit 1031-15. The transmitter 1031-1 may further include a modulator. Further, the transmitter 1031-1 may for example include a scramble unit (not shown), a modulation mapper (not shown), a layer mapper (not shown), and a layer permutator (not shown), which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some of constituent elements is referred to as a unit in the disclosure. However, the embodiments are not limited thereto. For example, such term “unit” is also referred to as a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21, a CP removing unit 1031-22, an FFT unit 1031-23, and an equalizing unit 1031-24. The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

1. A method for a terminal to monitor a new radio technology (NR) physical downlink control channel (PDCCH) in a wireless communication system, the method comprising:
monitoring a PDCCH in a single orthogonal frequency division multiplexing (OFDM) symbol or multiple OFDM symbols within a slot that is used for a long term evolution (LTE) cell-specific reference signal (CRS); and
receiving a demodulation reference signal (DM-RS) for decoding of the PDCCH in at least one OFDM symbol within the slot,
wherein a resource element (RE) used for the DM-RS for the decoding of the PDCCH does not overlap with an RE used for the LTE CRS.

2. The method of claim 1, wherein, in an event that the multiple OFDM symbols for monitoring the PDCCH include both i) symbols containing the LTE CRS and ii) symbols not containing the LTE CRS, the DM-RS for the decoding of the PDCCH is received from only through at least one of the multiple OFDM symbols not containing LTE CRS.

3. The method of claim 1, wherein DM-RS puncturing is applied to the RE used for the LTE CRS.

4. The method of claim 1, further comprising:
receiving configuration information of the LTE CRS.

5. The method of claim 4, wherein the configuration information of the LTE CRS comprises rate matching pattern configuration information of the LTE CRS for the PDCCH.

6. The method of claim 4, wherein the configuration information of the LTE CRS is received through a radio resource control (RRC) signaling.

7. A method for a base station to transmit a new radio technology (NR) physical downlink control channel (PDCCH) in a wireless communication system, the method comprising:
configuring a single orthogonal frequency division multiplexing (OFDM) symbol or multiple OFDM symbols within a slot to transmit the PDCCH, the slot being used for a long term evolution (LTE) cell-specific reference signal (CRS);
allocating a demodulation reference signal (DM-RS) for decoding of the PDCCH to at least one OFDM symbol within the slot; and
transmitting the PDCCH and the DM-RS for the decoding of the PDCCH,
wherein a resource element (RE) used for the DM-RS for the decoding of the PDCCH does not overlap with an RE used for the LTE CRS.

8. The method of claim 7, wherein, in an event that the multiple OFDM symbols include both i) symbols containing the LTE CRS and ii) symbols not containing the LTE CRS, the DM-RS for the decoding of the PDCCH is transmitted to only through at least one of the symbols not containing the LTE CRS.

9. The method of claim 7, wherein DM-RS puncturing is applied to the RE used for the LTE CRS.

10. The method of claim 7, further comprising:
transmitting configuration information of the LTE CRS.

11. The method of claim 10, wherein the configuration information of the LTE CRS comprises rate matching pattern configuration information of the LTE CRS for the PDCCH.

12. The method of claim 10, wherein the configuration information of the LTE CRS is transmitted through a radio resource control (RRC) signaling.

13. A communication device in a wireless communication system, comprising:
at least one processor; and
at least one memory configured to store instructions and operably electrically connectable to the at least one processor, wherein operations performed based on the instructions executed by the at least one processor comprise:
monitoring a new radio technology (NR) physical downlink control channel (PDCCH) in a single orthogonal frequency division multiplexing (OFDM) symbol or multiple OFDM symbols within a slot that is used for a long term evolution (LTE) cell-specific reference signal (CRS); and
receiving a demodulation reference signal (DM-RS) for decoding of the PDCCH in at least one OFDM symbol within the slot,
wherein a resource element (RE) used for the DM-RS for the decoding of the PDCCH does not overlap with an RE used for the LTE CRS.

14. (canceled)

15. (canceled)
